(19) United States
(12) Patent Application Publication
(10) Pub. No.: US 2024/0110580 A1
(43) Pub. Date: Apr. 4, 2024

(54) Hydraulic Accumulator

(71) Applicant: Hydac Technology GmbH, Sulzbach / Saar (DE)

(72) Inventor: Peter Kloft, Ransbach-Baumbach (DE)

(73) Assignee: Hydac Technology GmbH, Sulzbach / Saar (DE)

(21) Appl. No.: 18/555,303

(22) PCT Filed: Mar. 23, 2022
(86) PCT No.: PCT/EP2022/057651

§ 371 Date: Oct. 13, 2023

(30) Foreign Application Priority Data
Apr. 17, 2021 (DE) 10 2021 002 023.5

(51) Int. Cl. F15B 1/24; F15B 1/12; F15B 1/16

(52) U.S. Cl. CPC F15B 1/24; F15B 1/12; F15B 1/16

(57) ABSTRACT

2. A hydraulic accumulator, in particular a piston accumulator, comprising a separation element (16) which is movably arranged in an accumulator housing (10) and which separates two media chambers (24, 26) from each other, and comprising a distance measuring device for monitoring the position of the separation element (16), is characterized in that the distance measuring device is in the form of a radar device (32) that includes a transmitter (42) emitting a primary signal which upon at least partial reflection off the separation element (16), generates a secondary signal which, upon reception by a receiver (46), allows a position of the separation element (16) in the accumulator housing (10) to be determined.

### CROSS-REFERENCE TO RELATED APPLICATIONS

This application claims priority to German Patent Application No. DE 10 2021 002 023.5, filed on Apr. 17, 2021 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a hydraulic accumulator, in particular a piston accumulator, having a movable separating element which is arranged in an accumulator housing and which separates two media chambers from each other, and having a displacement measuring device for monitoring the position of the separating element.

DE 10 2014 105 154 A1 discloses a method together with associated cylinder arrangement which is suitable for detecting the position and/or movement of a piston in a cylinder having a longitudinal central axis, a liquid being present on a first piston side and a gas being present on a second piston side, and a beam of a virtually monochromatic wave being irradiated onto the second piston side at an angle of incidence different from 90° with respect to the direction of the longitudinal central axis, being reflected by the second piston side and the location of the beam impact being detected, as a result of which the position of the separating element in the form of the piston can be determined within an accumulator housing in the form of the cylinder.

The separating element, which is arranged so as to be longitudinally movable in the accumulator housing, regularly separates two media chambers within the accumulator housing from each other, the one media chamber as the so-called gas side having a compressible working gas, whereas the other media chamber as the so-called liquid side is used to accommodate liquids, such as hydraulic medium.

Hydraulic accumulators configured in such a way, such as hydropneumatic piston accumulators, are used in hydraulic systems to receive certain volumes of pressurised fluid, such as hydraulic oil, and to return it to the system as necessary. During operation of the hydraulic accumulator, the position of the separating element or the separating piston in the accumulator housing changes so that when the pressure increases in the other media chamber, the accumulator receives hydraulic oil, compressing the gas in the one media chamber. As the working pressure drops, the compressed gas then expands again and displaces the hydraulic oil accumulated in the process from the other media chamber back into the hydraulic circuit. The changes in the volumes of the media chambers which arise during operation result in an assignable axial movement of the separating element in each case.

In particular due to condensation processes, it has been shown in practice that moisture and thus mist can form on the gas side of the hydraulic accumulator, which impairs optical measurements. Even path detection by means of an ultrasonic displacement measuring device is adversely affected in this way. Furthermore, in the case of piston accumulators, it can happen over time that liquid enters the gas side of the accumulator unintentionally from the liquid side via the sealing and guide system on the outside of the separating piston, which also impairs the kinds of measurement mentioned. As a result of intense compression processes of the working gas due to the action of the separating element, in practice heat streaks of a sort have also formed on the gas side, which also impairs the measuring quality of the known methods. The known measuring methods also need transmitter and receiver devices at various locations at least in part on the cover side of the accumulator housing, which requires corresponding installation space, and it is necessary to selectively align the transmitter and receiver axis, including the reflective separating element, to be able to guarantee functionally reliable operation in this respect.

To counter these disadvantages, a hydropneumatic piston accumulator has been proposed in DE 10 2016 007 798 A1, having an accumulator housing which comprises a cylinder tube, defining a longitudinal axis, which cylinder tube is closed at both ends by a housing cover in each case and in which a piston is longitudinally movable as a separating element, which piston separates a working chamber for a compressible medium, such as a working gas, from a working chamber for an incompressible medium, such as hydraulic oil, in the housing and having a displacement measuring device, which determines the position of the piston in the housing without contact. The displacement measuring device comprises a non-magnetic measuring tube which extends through a lead-through formed in the piston along the longitudinal axis from one housing cover to the other housing cover and is sealed off from the interior of the housing, a position generator being displaceably guided in the tube and following the piston movements in the measuring tube by means of a magnetic force acting between it and the piston. A transmitter/receiver of the displacement measuring device is arranged on one of the housing covers of the accumulator housing, which transmitter/receiver transmits measuring radiation passing through the relevant open end of the measuring tube to the position generator and receives reflected radiation from the latter. In this way, the interior of the measuring tube forms a measuring zone that is independent of the physical state of the interior of the housing which provides a chamber with constant media pressure and media density for a measuring radiation, such as ultrasound, to pass through, it also being possible, in addition to ultrasound, to perform a laser measurement in this way. In particular, no condensate and/or hydraulic oil that might impair the measurement can enter the measuring zone of the measuring tube, which is closed off in this respect, and impair the measurement. However, the measuring tube requires a corresponding installation space in the accumulator housing, which reduces the volumes of the media chambers; volume that is then no longer available for energy storage.

### SUMMARY

A need exists to provide an improved hydraulic accumulator that allows a functionally reliable position monitoring of the separating element during operation.

The need is addressed by the subject matter of the independent claim(s). Embodiments of the invention are described in the dependent claims, the following description, and the drawings.

### BRIEF DESCRIPTION OF THE DRAWING

The FIG. shows an embodiment of a piston accumulator with installed radar unit as a displacement measuring device in the manner of a longitudinal section.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, the displacement measuring device is configured as a radar unit with a transmitter that emits a primary signal which, at least partially reflected by the separating element, generates a secondary signal which, received by a receiver, makes it possible to determine the position of the separating element in the accumulator housing, this creates a sensor device whose function or whose accurate measured value logging is not impaired by moisture, condensate, contamination from the liquid side, heat streaks, etc., due to the formation of the radar signal. On the contrary, due to the radar measured value logging, the interference factors mentioned above do not lead to inaccurate results in the position monitoring of the separating element in the accumulator housing. In this way, the solution according to the teachings herein allows improved and more accurate measured value logging with respect to the position of the separating element, without having to accommodate parts of the measuring device in the media chambers, thus saving installation space. Overall, the contents of a reservoir in the hydraulic accumulator can be determined very accurately by using the radar unit, indirectly via position determination of the separating element, and it can be ensured, for example, that the separating element, such as a separating piston, does not unintentionally strike an end position in the accumulator housing which could result in damage. The respective working situation (loading or unloading) for the hydraulic accumulator can also be determined via corresponding measured value electronics, which is helpful if hydraulic systems of machines and plants need to be controlled in the broader context.

By using the radar unit, the transmitter and receiver can be combined in one place in the accumulator housing so that the radar unit can be used for a hydraulic accumulator with little effort in terms of production and installation.

Accordingly, in some embodiments, it is provided that the transmitter and the receiver of the radar unit are combined in a structural unit which is arranged on a cover-like end part of the accumulator housing, the end part having a hollow duct which connects the structural unit to one of the two media chambers in a signal-carrying manner. In this respect, monitoring of the separating element with the radar signals of the radar unit is contact-free.

For securely closing off the media chambers with respect to the environment, it is provided that the hollow duct of the end part has a closure part transparent to the signals of the radar unit, said closure part being arranged between this structural unit and the adjacent media chamber. Without impairing radar emission and reception, the closure part can be formed of a glass or ceramic window in the end part. If, instead of a cover, the accumulator housing is provided with an accumulator wall extending in one piece, the structural component can also be inserted into a drilled hole in the relevant accumulator wall.

For emission and reception of the radar signals, it has proven beneficial for the radar unit in the form of the structural unit to be arranged coaxially with the longitudinal axis of the accumulator housing in the cover-like end part thereof.

In some embodiments, it is provided that the separating element is a separating piston which is guided so as to be longitudinally movable in the accumulator housing and which has a flat upper side extending transversely to the longitudinal axis of the accumulator housing which upper side serves as a reflective surface for the primary signals emitted by the radar unit. In contrast to the optical methods which, among other things, for example require a mirror-like reflective surface on the separating piston, in the course of radar recording there is no need for higher requirements on the reflective surface in the form of the upper side of the separating piston.

In addition to the separating piston mentioned as the separating element, the separating element can also consist of a thin-walled bellows by implementing a so-called bellows accumulator.

It has proven particularly beneficial for the signals of the radar unit to pass through the gas side of the hydraulic accumulator, even contamination entering on the gas side not impairing the quality of the radar measurement, or only to an insignificant extent. In addition or alternatively, there is also the option of monitoring the liquid side (oil side) of the accumulator by means of the radar unit.

For example, it is provided in a hydraulic accumulator that the function of the radar unit is based on the frequency-modulated continuous wave method, in which the frequency of a carrier frequency, as the primary signal, continuously emitted by a transmitter varies in a predefinable range and, as soon as the signal reflected by the separating element, as the secondary signal, arrives at the receiver, at least the distance, as the distance between the radar unit and the separating element, can be determined by frequency comparison in each travel position of the separating element. Thanks to the continuous wave method mentioned, the radar measurement can also be used for extremely small distances, such as occur in hydraulic accumulators, in a metrologically meaningful manner.

In some embodiments, it is provided that, in addition to determination of the distance within the scope of position monitoring, a determination of the speed of the separating element and/or a position determination of a separating element, such as an accumulator bladder or a separating diaphragm, is carried out in the accumulator housing by means of evaluation electronics of the radar unit. During operation of a hydraulic accumulator, separating elements, such as elastomeric accumulator bladders or separating diaphragms, can assume almost any external contours which are difficult or even impossible to detect with optical evaluation methods; but this is improved with measured value logging using a radar unit according to the teachings herein.

Since a very high number of hydraulic accumulators are already in use in the market worldwide, the embodiment of the radar unit as a structural unit in cartridge form allows the accumulator systems already supplied to be retrofitted with little retrofitting effort in the manner of a retrofit kit.

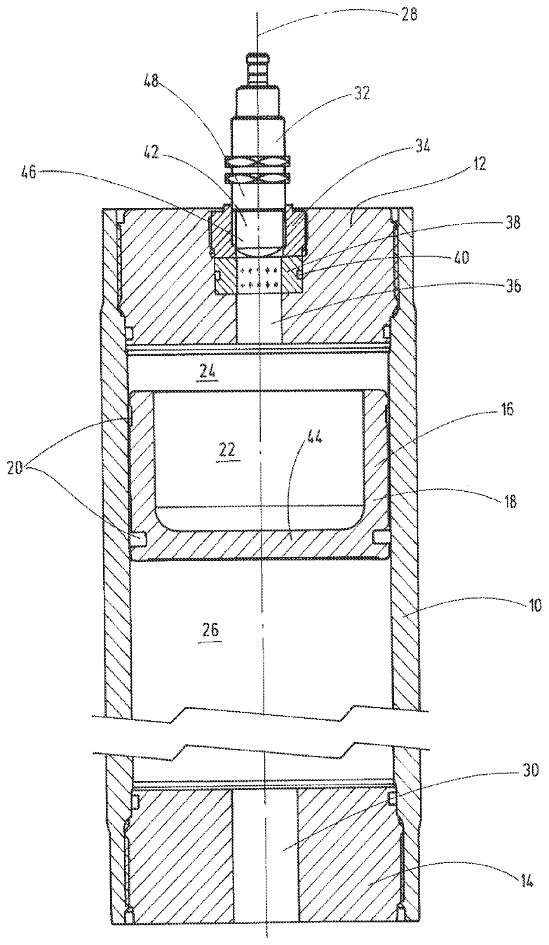

The hydraulic accumulator is explained in greater detail below with reference to an embodiment according to the FIG. 1n principle and not to scale, the only FIG. shows a piston accumulator with installed radar unit as a displacement measuring device in the manner of a longitudinal section.

Specific references to components, process steps, and other elements are not intended to be limiting.

The hydraulic accumulator shown in the drawing is designed as a so-called piston accumulator and has an accumulator housing denoted as a whole by 10. The accumulator housing 10 substantially forms a round hollow cylinder in the form of a cylindrical tube which is tightly closed at its two opposing ends by a screwed-in housing cover 12 and 14 respectively. In this respect, the two housing covers 12, 14 each form a cover-like end part for the accumulator housing 10. As separating element 16, a separating piston 18, which for this purpose has an annular sealing and guide system 20 on the outer circumferential side, is guided inside the accumulator housing 10 between the two end parts in the form of housing covers 12, 14. While maintaining substantially the same wall thickness, the separating piston 18 is provided with a cavity 22 which, in this respect, helps to volumetrically enlarge a media chamber 24 on the gas side of the piston accumulator relative to another media chamber 26 on the liquid side of the accumulator. In this respect, the separating piston 18 arranged so as to be longitudinally movable within the accumulator housing 10 separates the two media chambers 24, 26 from each other.

As viewed in the direction of the FIG., the lower housing cover 14 as the lower end part has a longitudinal or fluid duct 30 concentric with the longitudinal axis 28 of the accumulator housing, which facilitates liquid connection of the hydraulic accumulator to a hydraulic pipe network that is not shown in greater detail.

A radar unit 32 is arranged as a displacement measuring device on the upper housing cover 12. For this purpose, the radar unit 32 is screwed into the upper end part 12 in the form of the housing cover by means of a screw-in part 34. In this respect, the upper end part 12 has a hollow duct 36 which connects the radar unit 32 to the one upper media chamber 24 in the form of the gas side of the hydraulic accumulator in an optical or signal-carrying manner. In addition, a closure part 38, transparent to the signals of the radar unit 32, is introduced into the hollow duct 36 of the upper end part 12, which closure part is arranged between the radar unit 32 and the media chamber 24 adjacent thereto. The aforementioned closure part 38 can be formed of a glass or ceramic window which is inserted as a cylindrical insert into a corresponding recess in the housing cover 12 and is sealed outwardly with respect to the inside of the housing cover 12 via a sealing ring 40. Instead of an insert, the respective window can also be cast to fit perfectly into the corresponding recess in the housing cover 12. In an embodiment not shown in greater detail, it can also be provided that the transparent closure part is directly connected to the radar sensor as a functional unit. This results in a screw-in radar sensor which has the pressure-resistant window integrated in its one free end face.

The radar unit 32 has a transmitter 42 which emits a primary signal as radar signals. On the bottom, this primary signal is reflected by the upper side 44 of the separating piston 18 so that in this respect a radar signal sequence is generated as a secondary signal or echo signal. This secondary signal is in turn received by a receiver 46 of the radar unit 32, so that in this way, with appropriate evaluation of the receiver signals, position determination for the separating element 16 is enabled inside the accumulator housing 10.

As the FIG. further shows, the radar unit 32 in the manner or a screw-in cartridge is determined coaxially with the longitudinal axis 28 in the end part 12 or in the upper housing cover of the accumulator housing 10. In this respect, both the transmitter 42 and the receiver 46 are combined in one structural unit 48. The radar unit 32 operates according to the so-called frequency-modulated continuous wave method. As already explained, in this case the transmitter 42 of the radar unit 32 emits a primary signal in which the frequency increases with time. This results in a kind of frequency ramp, for example in the form of a sawtooth profile, the frequency ramp being repeated periodically and the difference between the minimum and maximum frequency technically being called the bandwidth B. Furthermore, the time between minimum and maximum frequency is referred to as ramp time T. During the ramp time, the frequency is continuously increased within the scope of frequency modulation, for example from 122 to 123 GHz.

When the emitted primary signal hits the separating element 16 in the beam cone of the radar unit 32, a portion of the emitted transmitter power is reflected which is detected by the receiver 46 as a secondary or echo signal. Due to the frequency ramp, the received secondary signal regularly has a lower frequency than the primary signal and the associated frequency shift FV is detected by evaluation electronics of the radar unit 32, which are not shown in greater detail, as a position measurement signal for the separating element 16. In this case, it can be assumed that the speed of the primary and secondary signal happens at the speed of light c.

According to the formula below, the distance S between the radar unit 32 and the separating element 16 can be calculated from the detected frequency shift FV captured by the radar unit 32 or its evaluation electronics, the ramp time T and the bandwidth B, taking into account the speed of light c:

$$S = \frac{c \cdot T \cdot FV}{2 \cdot B}$$

The radar unit 32 works with extremely narrow beam cones such that measuring ranges of less than one meter can readily be displayed. The measured value logging takes place in the millisecond range such that the movement of the separating element 16 in the accumulator housing 10 plays no role in determining the distance to a stationary reference point, such as the radar unit 32. In any case, the result is stable evaluation of measured values, even under adverse conditions in the media chamber 24, whether in the form of particulate contamination or in the form of heat or thermal streaks and moisture, regularly in the form of condensate. The radar unit 32 also operates reliably at extremely low temperatures of −10 to −40° C.

If the hydraulic accumulator is provided with a bellows instead of the movable separating element 16, the position of a reference surface of the bellows can likewise be monitored with the radar unit 32. In addition to the actual position monitoring of the respective separating element 16 within the scope of determining the distance by means of the radar unit 32, there is also the option of alternatively or additionally determining the speed of the movement for the respective separating element 16. If the separating element is formed of an elastically yielding accumulator bladder or a separating diaphragm, condition monitoring can also be carried out, if necessary, using the radar unit 32 to determine, for example, how much the individual accumulator bladder or separating diaphragm deforms during fluid operation. In this way, inadmissibly large flexing movements of the separating element can be counteracted by appropriate control on the liquid side of the hydraulic accumulator.

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module, or other unit or device may fulfill the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-10. (canceled)

11. A hydraulic accumulator, having a separating element which is movably arranged in an accumulator housing and which separates two media chambers from each other, and having a displacement measuring device for monitoring the position of the separating element, wherein the displacement measuring device is configured as a radar unit having a transmitter which transmits a primary signal which, at least partially reflected by the separating element, generates a secondary signal which, when received by a receiver, enables to determine a position for the separating element in the accumulator housing.

12. The hydraulic accumulator of claim 11, wherein the transmitter and the receiver of the radar unit are combined in a common structural unit which is arranged on a cover-like end part of the accumulator housing, and wherein the end part has a hollow duct which connects the common structural unit to one of the two media chambers in a signal-carrying manner.

13. The hydraulic accumulator of claim 11, wherein the hollow duct of the one end part has a closure part transparent to the signals of the radar unit which closure part is arranged between the common structural unit and the adjacent media chamber.

14. The hydraulic accumulator of claim 11, wherein the closure part is formed of a glass or ceramic window.

15. The hydraulic accumulator of claim 11, wherein the radar unit in the form of the common structural unit is arranged coaxially with the longitudinal axis of the accumulator housing in its one cover-like end part.

16. The hydraulic accumulator of claim 11, wherein the separating element is a separating piston which is guided so as to be longitudinally movable in the accumulator housing and which has a flat upper side extending transversely to the longitudinal axis of the accumulator housing which upper side serves as a reflective surface for the primary signals emitted by the radar unit.

17. The hydraulic accumulator of claim 11, wherein the separating element separates a gas side as the one media chamber from a liquid side as the other media chamber in the accumulator housing, and wherein the signals of at least one radar unit pass through the gas side and/or the liquid side.

18. The hydraulic accumulator of claim 11, wherein the function of the radar unit is based on a frequency-modulated continuous wave method, in which the frequency of a carrier frequency, as the primary signal, continuously emitted by a transmitter varies in a predefinable range and, as soon as the signal reflected by the separating element, as the secondary signal, arrives at the receiver, at least the distance, as the distance between the radar unit and the separating element, can be determined by frequency comparison in each travel position of the separating element.

19. The hydraulic accumulator of claim 11, wherein, in addition to determination of the distance within the scope of position monitoring, a determination of the speed of the separating element and/or a position determination of a separating element, such as an accumulator bladder or a separating diaphragm, is carried out in the accumulator housing using evaluation electronics of the radar unit.

20. The hydraulic accumulator of claim 11, wherein the common structural unit, designed as a cartridge-like radar sensor, can be inserted into the respective end part or into the accumulator housing itself.

21. The hydraulic accumulator of claim 11, wherein the hydraulic accumulator is a piston accumulator.

22. The hydraulic accumulator of claim 12, wherein the hollow duct of the one end part has a closure part transparent to the signals of the radar unit which closure part is arranged between the common structural unit and the adjacent media chamber.

23. The hydraulic accumulator of claim 12, wherein the closure part is formed of a glass or ceramic window.

24. The hydraulic accumulator of claim 13, wherein the closure part is formed of a glass or ceramic window.

25. The hydraulic accumulator of claim 12, wherein the radar unit in the form of the common structural unit is arranged coaxially with the longitudinal axis of the accumulator housing in its one cover-like end part.

26. The hydraulic accumulator of claim 13, wherein the radar unit in the form of the common structural unit is arranged coaxially with the longitudinal axis of the accumulator housing in its one cover-like end part.

27. The hydraulic accumulator of claim 14, wherein the radar unit in the form of the common structural unit is arranged coaxially with the longitudinal axis of the accumulator housing in its one cover-like end part.

28. The hydraulic accumulator of claim 12, wherein the separating element is a separating piston which is guided so as to be longitudinally movable in the accumulator housing and which has a flat upper side extending transversely to the longitudinal axis of the accumulator housing which upper side serves as a reflective surface for the primary signals emitted by the radar unit.

29. The hydraulic accumulator of claim 13, wherein the separating element is a separating piston which is guided so as to be longitudinally movable in the accumulator housing and which has a flat upper side extending transversely to the longitudinal axis of the accumulator housing which upper side serves as a reflective surface for the primary signals emitted by the radar unit.

30. The hydraulic accumulator of claim 14, wherein the separating element is a separating piston which is guided so as to be longitudinally movable in the accumulator housing and which has a flat upper side extending transversely to the longitudinal axis of the accumulator housing which upper side serves as a reflective surface for the primary signals emitted by the radar unit.
